(19) United States
(12) Patent Application Publication
(10) Pub. No.: US 2025/0196553 A1
(43) Pub. Date: Jun. 19, 2025

(54) TORSION BEAM

(71) Applicant: NIPPON STEEL CORPORATION, Tokyo (JP)

(72) Inventors: Keinosuke IGUCHI, Chiyoda-ku, Tokyo (JP); Masahiko SATO, Chiyoda-ku, Tokyo (JP)

(21) Appl. No.: 18/849,814

(22) PCT Filed: Jun. 1, 2022
(86) PCT No.: PCT/JP2022/022326

§ 371 Date: Sep. 23, 2024

(51) Int. Cl. B60G 7/00

(52) U.S. Cl. CPC B60G 7/00; B60G 2200/20

(57) ABSTRACT

A tubular torsion beam (10) extending in a longitudinal direction, the torsion beam including a center portion (11) and end portions (12) connected to both sides of the center portion (11), in which a ratio S1/(L1×t1) determined by a cross-sectional area S1 including an internal space in a transverse section, which is a cross section in the center portion (11) of the torsion beam (10) in the longitudinal direction, an outer surface circumferential length (L1) in the transverse section, and an average value t1 of a wall thicknesses in the center portion (11) of the torsion beam (10) in the longitudinal direction is 1.4 or more and less than 10.

### TECHNICAL FIELD OF THE INVENTION

The present invention relates to a torsion beam.

### RELATED ART

Conventionally, a torsion beam described in Patent Document 1 below has been known. In this torsion beam, a transverse section orthogonal to a longitudinal direction is a closed cross section. In this torsion beam, in order to adjust torsional rigidity in a predetermined range, a center portion of a steel pipe serving as a material in the longitudinal direction is deformed so as to have a substantially V-shaped cross section (substantially inverted V-shaped cross section).

### PRIOR ART DOCUMENT

### Patent Document

### Patent Document 1:

Japanese Unexamined Patent Application, First Publication No. 2019-26012

### SUMMARY OF INVENTION

### Problems to be Solved by the Invention

In this type of torsion beam, it is desired to suppress an increase in weight while ensuring bending rigidity.

The present invention has been made in view of the above circumstances, and an object of the present invention is to provide a torsion beam in which bending rigidity is ensured while an excessive increase in weight is suppressed.

### Means for Solving the Problem

In order to solve the above problem, the present invention proposes the following means.

(1) A torsion beam according to an aspect of the present invention is a tubular torsion beam extending in a longitudinal direction, the torsion beam including a center portion and end portions connected to both sides of the center portion, in which a ratio S1/(L1×t1) determined by a cross-sectional area S1 including an internal space in a transverse section, which is a cross section orthogonal to the longitudinal direction in the center portion of the torsion beam in the longitudinal direction, an outer surface circumferential length L1 in the transverse section, and an average value t1 of a wall thicknesses in the center portion of the torsion beam in the longitudinal direction is 1.4 or more and less than 10. Note that the internal space in the transverse section is a closed cross section.

The cross-sectional area S1 is related to torsional rigidity of the torsion beam. The larger the cross-sectional area S1, the higher the torsional rigidity. Therefore, when the torsional rigidity of the torsion beam is within a predetermined range, the cross-sectional area S1 has a value within a certain range according to the torsional rigidity.

The outer surface circumferential length L1 and the average value t1 of the wall thickness are related to the weight of the torsion beam. The longer the outer surface circumferential length L1 and the thicker the average value t1 of the wall thickness, the heavier the torsion beam.

Therefore, a low ratio S1/(L1×t1) indicates that the weight of the torsion beam tends to be large with respect to the torsional rigidity required for the torsion beam.

Note that the average value t1 of the wall thickness is calculated by obtaining a maximum value and a minimum value of the wall thickness in a transverse section, which is a cross section orthogonal to the longitudinal direction, and obtaining an average value of the maximum value and the minimum value.

Here, the cross-sectional area S1 is a sum of a wall cross-sectional area S1a and a spatial cross-sectional area S1b. The wall cross-sectional area S1a is a cross-sectional area of a wall constituting the tubular torsion beam. The spatial cross-sectional area S1b is a cross-sectional area of the internal space.

The outer surface circumferential length L1 and the average value t1 of the wall thickness described above are also related to the wall cross-sectional area S1a. The longer the outer surface circumferential length L1 and the thicker the average value t1 of the wall thickness, the larger the wall cross-sectional area S1a of the torsion beam.

A high ratio S1/(L1×t1) indicates that a ratio of the outer surface circumferential length L1 and the average value t1 of the wall thickness to the cross-sectional area S1 is low. That is, a high ratio S1/(L1×t1) indicates that a ratio of the wall cross-sectional area (cross-sectional area of a wall thickness portion) S1a to the cross-sectional area S1 is low and a ratio of the spatial cross-sectional area S1b to the cross-sectional area S1 is high. If torsional rigidity is kept constant, bending rigidity of the torsion beam is low when the ratio of the wall cross-sectional area S1a to the cross-sectional area S1 is low.

From the above, a high ratio S1/(L1×t1) indicates that the bending rigidity of the torsion beam tends to be low with respect to certain (appropriate) torsional rigidity.

In the torsion beam, the ratio S1/(L1×t1) is 1.4 or more and less than 10. By setting the ratio S1/(L1×t1) within an appropriate range, the bending rigidity of the torsion beam can be ensured without excessively increasing the weight of the torsion beam. That is, when the ratio S1/(L1×t1) is less than 1.4, the value of the ratio S1/(L1×t1) is too low, and the torsion beam may be excessively heavy. On the other hand, when the ratio S1/(L1×t1) is 10 or more, the value of the ratio S1/(L1×t1) is too high, and the bending rigidity of the torsion beam may be excessively low.

(2) In the torsion beam according to the above (1), a relationship between the average value t1 and the bending radius R may satisfy 1.5t1<R in the transverse section having a portion with the smallest bending radius R of the center portion in a circumferential direction. Note that the bending radius R is a bending radius of an inside of the bending of the torsion beam.

In the transverse section having a portion with the smallest bending radius R of the center portion in a circumferential direction, 1.5t1<R is satisfied. As a result, it is possible to suppress a decrease in fatigue strength of the inside of the bending of the torsion beam due to bending. Note that the bending radius R is a bending radius of the inside of the bending of the torsion beam.

(3) In the torsion beam according to the above (1) or (2), a material of the torsion beam may have a tensile strength of 780 MPa or more.

By setting the tensile strength of the material of the torsion beam to 780 MPa or more, fatigue properties of the torsion beam can be enhanced, and the torsion beam can be designed so as to be lightweight.

(4) In the torsion beam according to any one of the above (1) to (3), in the cross section in which a gap in the internal space is the smallest, the gap may be 1.0 mm or more.

By setting the gap to 1.0 mm or more in the transverse section having the smallest gap in the internal space, it is possible to suppress noise due to rubbing or collision between inner surface walls constituting the torsion beam at the time of using the torsion beam.

(5) In the torsion beam according to any one of the above (1) to (4), the outer surface circumferential length L1 may be less than an outer surface circumferential length L2 in a transverse section, which is a cross section of the end portion orthogonal to the longitudinal direction.

In this type of torsion beam, for the purpose of appropriately reducing torsional rigidity of the torsion beam while maintaining a connection strength between the torsion beam and trailing arms connected to both ends of the torsion beam, it may be necessary to make the cross-sectional area S1 of the center portion of the torsion beam lower than a cross-sectional area S2 of the end portion of the torsion beam.

In such a case, in the torsion beam as in the conventional technique, it is necessary to deform (hereinafter, referred to as volume reduction deformation) a center portion of a pipe serving as a material of the torsion beam so as to reduce an internal space and to process the center portion so as to have a substantially V-shaped cross section.

However, when the above-described center portion of the material is subjected to volume reduction deformation, stress concentration at the time of using the torsion beam or noise due to rubbing or collision between walls constituting the torsion beam may occur.

On the other hand, in the present torsion beam, the outer surface circumferential length L1 at the center portion of the torsion beam is less than the outer surface circumferential length L2 at the end portion of the torsion beam. Therefore, for example, when the shape of the transverse section at the center portion of the torsion beam is similar to the shape of the transverse section at the end portion of the torsion beam, the cross-sectional area S1 of the center portion of the torsion beam is inevitably lower than the cross-sectional area S2 of the end portion of the torsion beam. Therefore, in this case, for example, by shortening a cross-sectional width (for example, a diameter) of a transverse section of the center portion of the torsion beam while maintaining the shape of the transverse section, the cross-sectional area S1 of the center portion of the torsion beam can be made lower than the cross-sectional area S2 of the end portion of the torsion beam, and as a result, torsional rigidity of the torsion beam can be reduced. This makes it possible to design a lightweight torsion beam without causing such a problem as described above while minimizing a use amount of a material (without extra circumferential length).

Note that when the pipe serving as a material of the torsion beam has a constant diameter over the total length in the longitudinal direction, it is conceivable to process the center portion of the torsion beam to be smaller in diameter than the end portion in order to make the cross-sectional area S1 smaller than the cross-sectional area S2. As such a processing method, (a) a processing method of enlarging the diameter of the end portion of the pipe, (b) a processing method of reducing the diameter of the center portion of the pipe, and the like are conceivable. Examples of the former (a) include so-called bulge processing (hydraulic bulge processing or rubber bulge processing) in which a pressure medium is supplied into the pipe to expand a diameter, so-called flare processing by pressing, and so-called stepped processing using a punch. Examples of the latter (b) include so-called necking processing in which the pipe is locally squeezed using a roll.

(6) In the torsion beam according to any one of the above (1) to (5), the average value t1 may be 2.5 mm or more.

The average value t1 of the wall thickness of the center portion of the torsion beam is 2.5 mm or more. Therefore, bending rigidity of the torsion beam can be reliably increased.

(7) In the torsion beam according to any one of the above (1) to (6), in a cross section orthogonal to the longitudinal direction, a wall thickness of the torsion beam may be −20% or more and 0% or less of a maximum value of the wall thickness.

The wall thickness is preferably constant in a cross section perpendicular to the longitudinal direction. This is because if there is a portion having a thin wall thickness, stress concentrates at the portion, and the portion can be a starting point of fatigue fracture. However, in practice, the wall thickness may industrially vary in the circumferential direction. This is because even if there is this variation, if the variation is within a range of −20% or more and 0% or less, desirably −15% or more and 0% or less of a maximum value of the wall thickness in the circumferential direction (that is, the variation of the wall thickness in the circumferential direction is within a tolerance (−20% or more and 0% or less (desirably −15% or more and 0% or less) of the maximum value of the wall thickness), an adverse effect due to stress concentration at a portion where the wall thickness is thin can be ignored, and the wall thickness can be regarded to be substantially constant in the circumferential direction.

(8) In the torsion beam according to any one of the above (1) to (7), the transverse section at the center portion does not have to include a portion protruding toward the internal space.

The transverse section of the center portion of the torsion beam does not include a portion protruding toward the internal space. Therefore, for example, it is not necessary to subject the pipe serving as a material of the torsion beam to volume reduction deformation. In this case, for example, generation of residual stress can be suppressed.

Note that, in this case, examples of the specific shape of the center portion in the transverse section include a circular shape (for example, a perfect circular shape or an elliptical shape) and a polygonal shape (a rectangular shape (a square shape or a rectangular shape), or a triangular shape). Here, when the shape of the transverse section is a perfect circle, S1/L1 which is a ratio between the cross-sectional area S1 and the outer surface circumferential length L1 can be geometrically obtained to be S1/L1=0.5·R1 (in which R1 is the radius of the outer surface of the center portion). On the other hand, when the shape of the transverse section is a square, S1/L1 can be obtained to be S1/L1≈0.39·R1′ (in which R1′ is the equivalent radius of the outer surface of the center portion). When the shape of the transverse section is an equilateral triangle, S1/L1 can be obtained to be S1/L1≈0.3·R1′ (in which R1′ is the equivalent radius of the outer surface of the center portion). Therefore, when S1/L1 and the ratio S1/(L1×t1) calculated based on S1/L1 are constant values, the radius (equivalent radius) increases in the order of a perfect circle, a square, and an equilateral triangle. In other words, when the cross-sectional area S1 has a constant value, it can be said that the outer surface circumferential length L1 increases in the order of a perfect circle, a square, and an equilateral triangle. Here, the outer surface circumferential length L1 is related to bending rigidity as described above. Therefore, when the cross-sectional area S1 is a constant value, it can be said that the bending rigidity increases in the order of a perfect circle, a square, and an equilateral triangle.

Therefore, for example, in a case where the shape of the transverse section of the center portion of the torsion beam is a perfect circle, and the bending rigidity is excessively lowered as a result of lowering the value of the cross-sectional area S1 in a process of adjusting the torsional rigidity, an excessive decrease in bending rigidity may be able to be suppressed by setting the shape of the transverse section to a square shape, an equilateral triangle shape, or the like instead of a circular shape.

In addition, even when a shape of the transverse section is formed such that there is a sufficient gap (1.0 mm or more, desirably 1.5 mm or more, more desirably 2 mm or more) on an inner surface unlike the case where the shape of the cross section is a substantially V-shape in which inner surfaces of a material are in close contact with each other, it is possible to similarly suppress an excessive decrease in bending rigidity.

(9) In the torsion beam according to any one of the above (1) to (8), an axis of the center portion in the longitudinal direction and an axis of the end portion in the longitudinal direction may be shifted from each other. Note that the axis means a line connecting centroids of transverse sections.

The axis of the center portion of the torsion beam and the axis of the end portion of the torsion beam are shifted from each other. That is, the center portion and the end portion of the torsion beam are not limited to be coaxial. Therefore, for example, the degree of freedom of the shape of the torsion beam can be increased. As a result, a layout can be diversified, for example, the torsion beam is designed so as to avoid other structures in a vehicle.

(10) In the torsion beam according to the above (9), the axis of the center portion may be a curve.

The axis of the center portion of the torsion beam is a curve. That is, the axis of the center portion of the torsion beam is not limited to a straight line. Therefore, for example, the degree of freedom of the shape of the torsion beam can be increased. As a result, a layout can be diversified, for example, the torsion beam is designed so as to avoid other structures in a vehicle.

When the axis of the center portion is a curve, it is conceivable to manufacture a torsion beam by bending a pipe serving as a material of the torsion beam. This type of bending is often difficult when the transverse section of the center portion of the torsion beam includes a portion protruding toward an internal space. In other words, when the transverse section of the center portion of the torsion beam does not include a portion protruding toward the internal space, this type of bending is easily performed.

(11) In the torsion beam according to any one of the above (1) to (10), the average value t1 and an average value t2 of the wall thickness at the end portion may be different from each other.

The average value t1 of the wall thickness of the center portion of the torsion beam is different from the average value t2 of the wall thickness of the end portion. Therefore, an appropriate wall thickness can be adopted according to a position in the longitudinal direction. As a result, the quality of the torsion beam can be improved. Note that, for example, it is considered that t1<t2 is preferable in many cases from a viewpoint of attaching the end portion of the torsion beam to a trailing arm.

As a method for making t1 and t2 different from each other, for example, a method for manufacturing a pipe serving as a material of a torsion beam by subjecting a tailored blank obtained by joining a plurality of steel sheets having different wall thicknesses to UO formation is conceivable.

### Effects of the Invention

According to the present invention, it is possible to provide a torsion beam in which bending rigidity is ensured while an excessive increase in weight is suppressed.

### BRIEF DESCRIPTION OF THE DRAWINGS

FIG. 1 is a perspective view showing a schematic configuration of a torsion beam type rear suspension device according to an embodiment of the present invention.

FIG. 2 is a view for showing a schematic configuration of a torsion beam assembly according to the embodiment, and is a perspective view as viewed from below.

FIG. 3 is a perspective view for showing a schematic configuration of the torsion beam according to the embodiment.

FIG. 4 is a plan view for showing a schematic configuration of the torsion beam according to the embodiment.

FIG. 5 is a view illustrating a schematic configuration of the torsion beam according to the embodiment, and is a closed cross-sectional view when viewed in an arrow V-V direction in FIG. 4.

FIG. 6 is a view illustrating a schematic configuration of the torsion beam according to the embodiment, and is a closed cross-sectional view when viewed in an arrow VI-VI direction in FIG. 4.

FIG. 7 is a view illustrating a schematic configuration of the torsion beam according to the embodiment, and is a closed cross-sectional view when viewed in an arrow VII-VII direction in FIG. 4.

FIG. 8 is a view illustrating a schematic configuration of a torsion beam according to a first modification example of the present invention, and is a closed cross-sectional view corresponding to a case of being viewed in the arrow V-V direction in FIG. 4.

FIG. 9 is a view illustrating a schematic configuration of a torsion beam according to a second modification example of the present invention, and is a closed cross-sectional view corresponding to a case of being viewed in the arrow V-V direction in FIG. 4.

FIG. 10 is a view illustrating a schematic configuration of a torsion beam according to a third modification example of the present invention, and is a closed cross-sectional view corresponding to a case of being viewed in the arrow V-V direction in FIG. 4.

FIG. 11 is a perspective view illustrating a schematic configuration of a torsion beam according to a fourth modification example of the present invention.

FIG. 12 is a perspective view illustrating a schematic configuration of a torsion beam according to a fifth modification example of the present invention.

FIG. 13 is a view illustrating a schematic configuration of a torsion beam according to Comparative Example of the present invention, and is a closed cross-sectional view corresponding to a case of being viewed in the arrow V-V direction in FIG. 4.

### EMBODIMENT OF THE INVENTION

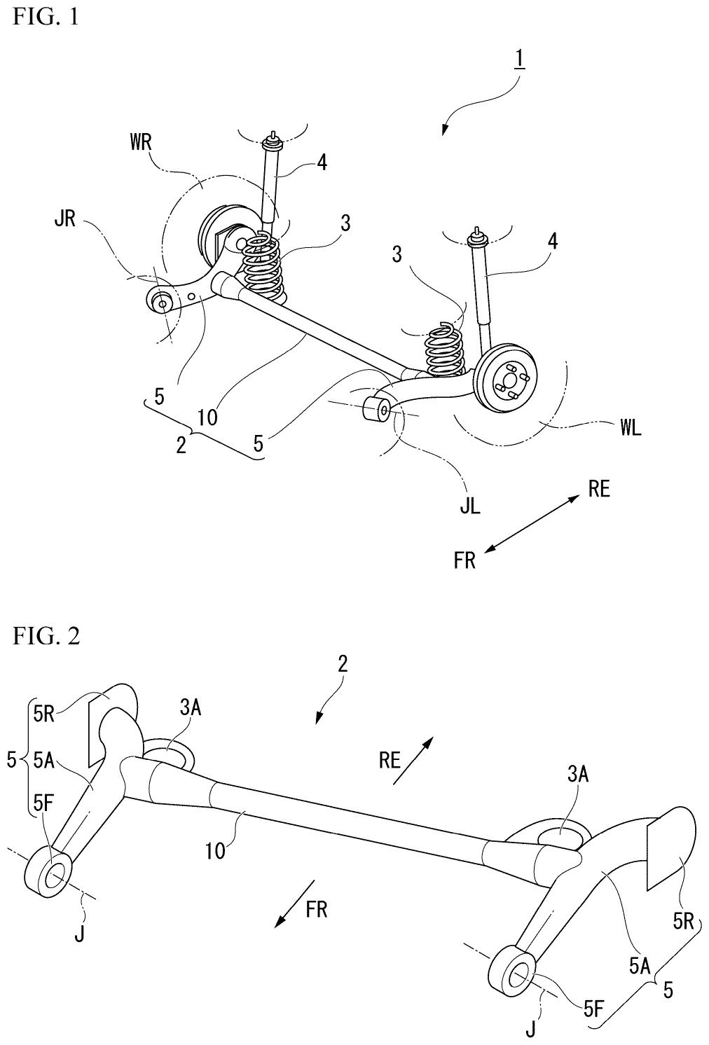

Hereinafter, an embodiment of the present invention will be described with reference to FIGS. 1 to 7.

FIG. 1 is a diagram illustrating a schematic configuration of a torsion beam type rear suspension device (torsion beam type suspension device) according to the present embodiment. FIG. 1 illustrates a torsion beam type rear suspension device 1, a torsion beam assembly 2, and a torsion beam 10. Note that FIG. 1 illustrates a front FR and a rear RE of a vehicle (not illustrated) on which the torsion beam type rear suspension device 1 is mounted.

### (Torsion Beam Type Rear Suspension Device)

As illustrated in FIG. 1, the torsion beam type rear suspension device 1 includes the torsion beam assembly 2, and a spring 3 and an absorber 4 that connect the torsion beam assembly 2 and a vehicle body (not illustrated).

The torsion beam assembly 2 supports left and right wheels WL and WR with a pair of left and right trailing arms 5, and is connected to the vehicle body via pivot axes JL and JR extending from left and right sides of the vehicle body toward a slightly forward center side. The torsion beam assembly 2 is configured to be swingable with respect to the vehicle body.

As illustrated in FIG. 2, the torsion beam assembly 2 includes, for example, the pair of left and right trailing arms (arms) 5, the torsion beam 10 connecting the trailing arms 5, and a pair of left and right spring receiving portions 3A supporting the spring 3. One end side of the absorber 4 serving as a damping device is connected to a buffer receiving portion (not illustrated).

The trailing arm 5 includes, for example, a trailing arm body 5A, a pivot attachment member 5F connected to a front side end of the trailing arm body 5A and supported by the vehicle body via a pivot axis J, and a wheel attachment member 5R connected to a rear side end of the trailing arm body 5A and supporting the wheel WL or WR.

The spring receiving portion 3A is disposed on a side opposite to the pivot attachment member 5F with the torsion beam 10 interposed therebetween, and one end side of the spring 3 is attached to the spring receiving portion 3A. A load received from a road surface is transmitted to the vehicle via the wheels WL and WR, the trailing arm 5, and the spring 3.

### (Torsion Beam)

A torsion beam is required to have rigidity against bending about a vehicle body vertical direction axis for holding a tire as a rotation center. For example, when a lateral force is generated in the tire, the torsion beam is tensioned to obtain rigidity for holding the tire. At the same time, when there is a difference in force applied from the ground to the left and right tires at a corner or the like, torsion occurs around a beam axis direction. Therefore, against this torsion, the torsion beam is required to have a function of being tensioned with appropriate rigidity (not too large or too small) to suppress roll of the vehicle.

Hereinafter, the torsion beam 10 according to the present embodiment will be described with reference to FIGS. 3 to 7.

In this torsion beam 10, a transverse section, which is a cross section orthogonal to the longitudinal direction is a closed cross section. The torsion beam 10 has a hollow and tubular shape with an internal space. In the present embodiment, the shape of the transverse section of the torsion beam 10 is a perfect circular shape over the total length in the longitudinal direction. The torsion beam 10 has a circular tube shape.

A material of the torsion beam 10 has a tensile strength of preferably 780 MPa or more, more preferably 980 MPa or more. The tensile strength of the material of the torsion beam 10 is preferably 1380 MPa or less, and more preferably 1180 MPa or less. The length of the torsion beam 10 is not particularly limited, but may be, for example, 500 mm or more and 1800 mm or less. The weight of the torsion beam 10 is not particularly limited, but may be, for example, 2 kg or more and 20 kg or less.

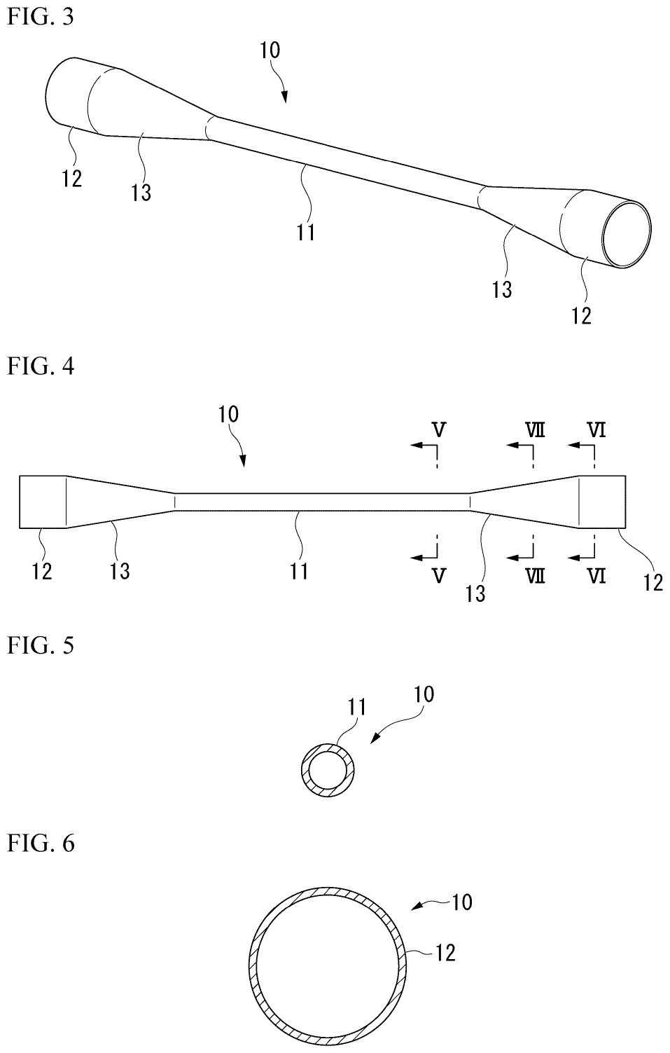

As illustrated in FIGS. 3 and 4, the torsion beam 10 includes a center portion 11 and an end portion 12 in the longitudinal direction, and a shape changing portion 13 connecting the center portion 11 and the end portion 12.

The center portion 11 has the same diameter regardless of a position in the longitudinal direction. The end portion 12 has the same diameter regardless of a position in the longitudinal direction. The center portion 11 and the end portion 12 each have a circular tube shape.

The center portion 11 has a smaller diameter than the end portion 12. A transverse section of the center portion 11 is similar to a transverse section of the end portion 12. Both ends of the center portion 11 in the longitudinal direction are connected to the respective shape changing portions 13. The center portion 11 is longer in the longitudinal direction than the end portion 12. The length of the center portion 11 is 2 times or more and 20 times or less the length of the end portion 12.

Note that, in the present embodiment, since the center portion 11 has a smaller diameter than the end portion 12 as described above, an outer surface circumferential length L1 in the transverse section of the center portion 11 is less than an outer surface circumferential length L2 in the transverse section of the end portion 12. Note that L1 is an outer surface circumferential length of the center portion 11 in a transverse section orthogonal to the longitudinal direction. L2 is an outer surface circumferential length of the end portion 12 in a transverse section orthogonal to the longitudinal direction.

Here, the outer surface circumferential length L1 of the center portion 11 can be, for example, an average value of outer surface circumferential lengths at each of the four boundaries of each region when the center portion 11 is equally divided into five regions in the longitudinal direction. The outer surface circumferential length L2 of the end portion 12 can also be defined in a similar manner to the outer surface circumferential length L1 of the center portion 11.

Note that the outer surface circumferential length L1 is not particularly limited, but may be, for example, 90 mm or more and 300 mm or less. The outer surface circumferential length L2 is not particularly limited, but may be, for example, 150 mm or more and 600 mm or less.

The diameter of the shape changing portion 13 continuously increases from the center portion 11 toward the end portion 12. The shape changing portion 13 has a truncated cone shape. In the shape changing portion 13, an end edge near a center of the torsion beam 10 in the longitudinal direction is connected to the center portion 11, and an end edge of the torsion beam 10 on an outer side in the longitudinal direction is connected to the end portion 12.

Note that the center portion 11, the end portion 12, and the shape changing portion 13 are each formed in a straight tubular shape. In other words, axes of the center portion 11, the end portion 12, and the shape changing portion 13 extend linearly. The axes are located on a common axis. That is, the center portion 11, the end portion 12, and the shape changing portion 13 are coaxially arranged. Note that the axis means a line connecting centroids of transverse sections.

As described above, the shape of the transverse section of the torsion beam 10 is a perfect circular shape over the total length in the longitudinal direction. In other words, the transverse section of the torsion beam 10 does not include a portion protruding toward the internal space regardless of a position of the torsion beam 10 in the longitudinal direction. That is, none of the transverse sections of the center portion 11, the end portion 12, and the shape changing portion 13 includes a portion protruding toward the internal space.

The wall thickness (sheet thickness) of the torsion beam 10 is substantially almost constant regardless of a position in the longitudinal direction, a position in a circumferential direction at a transverse section, or the like. In other words, the average value t1 of the wall thickness of the center portion 11, the average value t2 of the wall thickness of the end portion 12, and the average value t3 of the wall thickness of the shape changing portion 13 are equivalent (substantially almost constant).

In the present embodiment, the average value of the wall thickness (sheet thickness) of the torsion beam 10 is 2.5 mm or more.

Note that the average value t1 of the wall thickness of the center portion 11 can be, for example, an average value of wall thicknesses at each of the four boundaries of each region when the center portion 11 is equally divided into five regions in the longitudinal direction. Note that the wall thickness at each of the boundaries is calculated by obtaining a maximum value and a minimum value of the wall thickness in a transverse section orthogonal to the longitudinal direction, and obtaining an average value of the maximum value and the minimum value. In the present embodiment, the thickness in each region is an average value of the maximum value and the minimum value of the wall thickness in the transverse section of the region. The wall thickness t2 of the end portion 12 and the wall thickness t3 of the shape changing portion 13 can also be defined similarly to the average value t1 of the wall thicknesses of the center portion 11.

Here, in the transverse section, if the wall thickness of the torsion beam is within a range of −20% or more and 0% or less (desirably −15% or more and 0% or less) of a maximum value of the wall thickness (that is, a variation of the wall thickness in the circumferential direction is within a tolerance (−20% or more and 0% or less (desirably-15% or more and 0% or less) of the maximum value of the wall thickness), the wall thickness can be regarded to be substantially almost constant in the circumferential direction. That is, when the wall thickness of the torsion beam is within 80% or more and 100% or less (desirably −15% or more and 0% or less) of the maximum value, the wall thickness can be regarded to be substantially almost constant in the circumferential direction. Note that the wall thickness is preferably constant in the transverse section. This is because if there is a portion having a thin wall thickness, stress concentrates at the portion, and the portion can be a starting point of fatigue fracture. However, in practice, the wall thickness may industrially vary in the circumferential direction. This is because even if there is this variation, if the variation is within a range of −20% or more and 0% or less, desirably −15% or more and 0% or less of a maximum value of the wall thickness in the circumferential direction, an adverse effect due to stress concentration at a portion where the wall thickness is thin can be ignored, and the wall thickness can be regarded to be substantially constant in the circumferential direction.

In addition, the fact that t1 to t3 are equivalent (substantially almost constant) includes not only a case where t1 to t3 completely coincide with each other, but also a case where t1 to t3 are slightly different from each other and substantially coincide with each other. The case where t1 to t3 are slightly different from each other can be, for example, a case where a difference between the smallest value and the largest value among t1 to t3 is less than 5% of the largest value.

In the present embodiment, the ratio S1/(L1×t1) determined by the cross-sectional area S1 including the internal space in the transverse section of the center portion 11, the outer surface circumferential length L1, and the average value t1 of the wall thickness of the center portion 11 is 1.4 or more and less than 10.

The cross-sectional area S1 is a sum of the wall cross-sectional area S1a and the spatial cross-sectional area S1b. The wall cross-sectional area S1a is a cross-sectional area of a wall constituting the torsion beam 10. The spatial cross-sectional area S1b is a cross-sectional area of the internal space.

Here, the wall cross-sectional area S1a of the center portion 11 can be, for example, an average value of wall cross-sectional areas at each of the four boundaries of each region when the center portion 11 is equally divided into five regions in the longitudinal direction. The spatial cross-sectional area S1b can also be defined in a similar manner to the wall cross-sectional area S1a.

Note that the cross-sectional area S1 is not particularly limited, but may be, for example, 650 mm² or more and 7000 mm² or less. The wall cross-sectional area S1a is not particularly limited, but may be, for example, 135 mm² or more and 1200 mm² or less. The spatial cross-sectional area S1b is not particularly limited, but may be, for example, 100 mm² or more and 6500 mm² or less.

The center portion 11 has a smaller diameter than the end portion 12, and the cross-sectional area S1 is smaller than the cross-sectional area S2 of the end portion 12. The cross-sectional area S2 of the end portion 12 is not particularly limited, but may be, for example, 800 mm² or more and 28000 mm² or less.

### (Method for Manufacturing Torsion Beam)

The torsion beam 10 can be manufactured from, for example, a steel pipe (not illustrated) serving as a material of the torsion beam 10. Note that the steel pipe may be any steel pipe such as a forged steel pipe, an electric resistance welded steel pipe, a seamless steel pipe, or an arc welded steel pipe (for example, a UOE steel pipe).

Here, when the steel pipe has a constant diameter over the total length in the longitudinal direction, it is conceivable to process the center portion 11 of the torsion beam 10 to be smaller in diameter than the end portion 12 in order to make the cross-sectional area S1 smaller than the cross-sectional area S2. As such a processing method, (a) a processing method of enlarging the diameter of the end portion 12 of the steel pipe, (b) a processing method of reducing the diameter of the center portion 11 of the steel pipe, and the like are conceivable. Examples of the former (a) include so-called bulge processing (hydraulic bulge processing or rubber bulge processing) in which a pressure medium is supplied into the steel pipe to expand a diameter, so-called flare processing by pressing, and so-called stepped processing using a punch. Examples of the latter (b) include so-called necking processing in which the steel pipe is locally squeezed using a roll.

### (Operation and Effects Regarding Ratio S1/(L1×t1))

The cross-sectional area S1 is related to torsional rigidity of the torsion beam 10.

The larger the cross-sectional area S1, the higher the torsional rigidity. Therefore, when the torsional rigidity of the torsion beam 10 is within a predetermined range, the cross-sectional area S1 has a value within a certain range according to the torsional rigidity.

The outer surface circumferential length L1 and the average value t1 of the wall thickness are related to the weight of the torsion beam 10. The longer the outer surface circumferential length L1 and the thicker the average value t1 of the wall thickness, the heavier the torsion beam 10.

Therefore, a low ratio S1/(L1×t1) indicates that the weight of the torsion beam tends to be large with respect to the torsional rigidity required for the torsion beam 10.

The outer surface circumferential length L1 and the average value t1 of the wall thickness described above are also related to the wall cross-sectional area S1a. The longer the outer surface circumferential length L1 and the thicker the average value t1 of the wall thickness, the larger the wall cross-sectional area S1a of the torsion beam 10.

A high ratio S1/(L1×t1) indicates that a ratio of the outer surface circumferential length L1 and the average value t1 of the thickness to the cross-sectional area S1 is low. That is, a high ratio S1/(L1×t1) indicates that a ratio of a wall cross-sectional area S1a to the cross-sectional area S1 is low and a ratio of the spatial cross-sectional area S1b to the cross-sectional area S1 is high. If torsional rigidity is kept constant, bending rigidity of the torsion beam 10 decreases when the ratio of the wall cross-sectional area S1a to the cross-sectional area S1 is low.

From the above, a high ratio S1/(L1×t1) indicates that the bending rigidity of the torsion beam 10 tends to be low with respect to certain (appropriate) torsional rigidity.

In the torsion beam 10, the ratio S1/(L1×t1) is 1.4 or more and less than 10. By setting the ratio S1/(L1×t1) within an appropriate range, the bending rigidity of the torsion beam 10 can be ensured without excessively increasing the weight of the torsion beam 10. That is, when the ratio S1/(L1×t1) is less than 1.4, the value of the ratio S1/(L1×t1) is too low, and the torsion beam 10 may be excessively heavy. On the other hand, when the ratio S1/(L1×t1) is 10 or more, the value of the ratio S1/(L1×t1) is too high, and the bending rigidity of the torsion beam 10 may be excessively low.

The ratio S1/(L1×t1) is preferably less than 5, and more preferably less than 3.

### (Operation and Effects Regarding Outer Surface Circumferential Lengths L1 and L2)

By the way, in this type of torsion beam 10, for the purpose of appropriately reducing torsional rigidity of the torsion beam 10 while maintaining connection strength between the torsion beam 10 and the trailing arm 5 connected to both ends of the torsion beam 10, it may be necessary to make the cross-sectional area S1 of the center portion 11 of the torsion beam 10 lower than the cross-sectional area S2 of the end portion 12 of the torsion beam 10.

In such a case, in a torsion beam 100 as in the conventional technique (see FIG. 13), it is necessary to deform (hereinafter, referred to as volume reduction deformation) a center portion 11 of a steel pipe serving as a material of the torsion beam 100 so as to reduce an internal space and to process the center portion 11 so as to have a substantially V-shaped cross section in which inner surface sides are in close contact with each other.

However, when the above-described center portion 11 of the material is subjected to volume reduction deformation to have a substantially close contact shape, stress concentration at the time of using the torsion beam or noise due to rubbing or collision between walls constituting the torsion beam may occur.

On the other hand, in the present torsion beam 10 according to the present embodiment, the outer surface circumferential length L1 at the center portion 11 of the torsion beam 10 is less than the outer surface circumferential length L2 at the end portion 12 of the torsion beam 10. Therefore, for example, when the shape of the transverse section at the center portion 11 of the torsion beam 10 is similar to the shape of the transverse section at the end portion 12 of the torsion beam 10, the cross-sectional area S1 of the center portion 11 of the torsion beam 10 is inevitably lower than the cross-sectional area S2 of the end portion 12 of the torsion beam 10. Therefore, in this case, for example, by shortening a cross-sectional width (a diameter) of a transverse section of the center portion 11 of the torsion beam 10 while maintaining the shape of the transverse section, the cross-sectional area S1 of the center portion 11 of the torsion beam 10 can be made lower than the cross-sectional area S2 of the end portion 12 of the torsion beam 10, and as a result, torsional rigidity of the torsion beam 10 can be reduced. As a result, the above-described problem does not occur, and for example, fatigue properties of the torsion beam 10 can be improved.

### MODIFICATION EXAMPLES

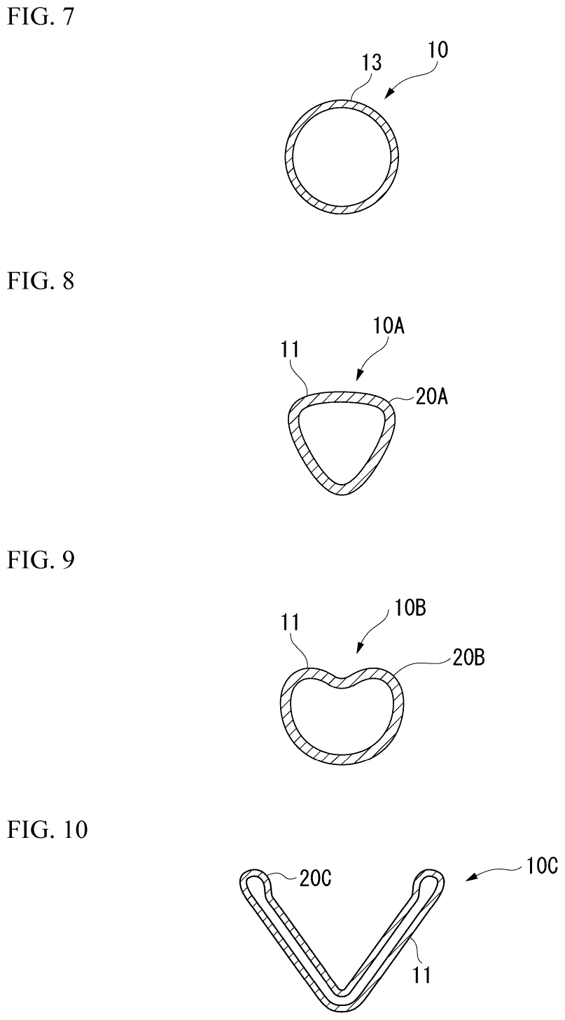

Next, modification examples according to the present invention will be described with reference to FIGS. 8 to 12.

Note that, in the modification examples, the same components as those in the above embodiment are denoted by the same reference numbers, description thereof is omitted, and only different points will be described.

### First Modification Example

As illustrated in FIG. 8, in a torsion beam 10A according to a first modification example, the transverse section of the center portion 11 and the transverse section of the end portion 12 do not have similar shapes. That is, the transverse section of the end portion 12 has a perfect circular shape as in the above embodiment, whereas the transverse section of the center portion 11 has a triangular shape. Note that, also in the torsion beam 10A according to the present modification example, as in the torsion beam according to the above embodiment, none of the transverse sections of the center portion 11, the end portion 12, and the shape changing portion 13 includes a portion protruding toward the internal space.

Examples of such a shape that does not include a portion protruding toward the internal space include an elliptical shape, a square shape, and an equilateral pentagonal shape in addition to a perfect circular shape and an equilateral triangular shape. That is, examples of the shape include a circular shape including a perfect circular shape, an elliptical shape, and the like, an equilateral polygonal shape including an equilateral triangular shape, a square shape, an equilateral pentagonal shape, and the like, and a polygonal shape including the equilateral polygonal shape. Alternatively, the shape may be a rectangular shape. Naturally, each corner portion or each side portion of the polygonal shape may have a curvature that is recessed toward the internal space.

As described above, examples of the specific shape of the center portion 11 in the transverse section include a circular shape (for example, a perfect circular shape or an elliptical shape) and a polygonal shape (a rectangular shape (a square shape or a rectangular shape), or a triangular shape). Here, when the shape of the transverse section is a perfect circle, S1/L1 which is a ratio between the cross-sectional area S1 and the outer surface circumferential length L1 can be geometrically obtained to be S1/L1=0.5·R1 (in which R1 is the radius of the outer surface of the center portion 11). On the other hand, when the shape of the transverse section is a square, S1/L1 can be obtained to be S1/L1≈0.39·R1′ (in which R1′ is the equivalent radius of the outer surface of the center portion 11). When the shape of the transverse section is an equilateral triangle, S1/L1 can be obtained to be S1/L1≈0.3·R1′ (in which R1′ is the equivalent radius of the outer surface of the center portion 11). Therefore, when S1/L1 and the ratio S1/(L1×t1) calculated based on S1/L1 are constant values, the radius (equivalent radius) increases in the order of a perfect circle, a square, and an equilateral triangle. In other words, when the cross-sectional area S1 has a constant value, it can be said that the outer surface circumferential length L1 increases in the order of a perfect circle, a square, and an equilateral triangle. Here, the outer surface circumferential length L1 is related to bending rigidity as described above. Therefore, when the cross-sectional area S1 is a constant value, it can be said that the bending rigidity increases in the order of a perfect circle, a square, and an equilateral triangle.

Therefore, for example, in a case where the shape of the transverse section of the center portion 11 of the torsion beam 10A is a perfect circle, and the bending rigidity is excessively lowered as a result of lowering the value of the cross-sectional area S1 in a process of adjusting the torsional rigidity, there is a case where an excessive decrease in bending rigidity can be suppressed by setting the shape of the transverse section to a square shape, an equilateral triangle shape, or the like instead of a circular shape.

In the first modification example, in a transverse section having a portion with the smallest bending radius R of the center portion 11 in the circumferential direction, a relationship between the average value t1 of the wall thickness of the center portion 11 and the bending radius R satisfies 1.5t1<R. As illustrated in FIG. 8, 1.5t1<R is satisfied in a transverse section of a triangular corner portion 20A having the smallest bending radius R. As a result, it is possible to suppress a decrease in fatigue strength of the inside of the torsion beam due to bending. In the transverse section having a portion with the smallest bending radius R, more preferably, 1.7t1<R is satisfied. Note that the bending radius R is a bending radius of an inside of the triangular corner portion 20A.

As a torsion beam according to a further modification example of the torsion beam 10A according the first modification example, a shape is exemplified in which the transverse section of the center portion 11 and the transverse section of the end portion 12 do not have similar shapes similarly to the torsion beam 10A according to the first modification example, but the transverse section of the end portion 12 is not a perfect circular shape.

### Second Modification Example

As illustrated in FIG. 9, in a torsion beam 10B according to a second modification example, the transverse section of the center portion 11 and the transverse section of the end portion 12 do not have similar shapes similarly to the torsion beam 10A according to the first modification example. Note that, in the torsion beam 10B according to the present modification example, the transverse section of the center portion 11 includes a portion protruding toward the internal space. The transverse section of the center portion 11 has a heart shape.

In the second modification example, the transverse section having a portion with the smallest bending radius R of the center portion 11 in the circumferential direction is a heart-shaped corner portion 20B as illustrated in FIG. 9. Note that the bending radius R is a bending radius of an inside of the heart-shaped corner portion 20B. When a relationship between the average value t1 of the wall thickness of the center portion 11 and the bending radius R satisfies 1.5t1<R in the transverse section having a portion with the smallest bending radius R of the center portion 11 in the circumferential direction, it is possible to suppress a decrease in fatigue strength of the inside of the torsion beam due to bending. In the transverse section having a portion with the smallest bending radius R, more preferably, 1.7t1<R is satisfied.

### Third Modification Example

As illustrated in FIG. 10, in a torsion beam 10C according to a third modification example, the transverse section of the center portion 11 includes a portion protruding toward the internal space. The transverse section of the center portion 11 has a substantially V-shape with a gap in the internal space.

The transverse section having the smallest gap in the internal space is the inside of the corner portion 20C. By setting the gap to 1.0 mm or more in the transverse section having the smallest gap in the internal space, the gap is maintained at the time of torsional deformation, and bending rigidity can be ensured. In addition, when the torsion beam is used, it is possible to suppress noise due to rubbing or collision between walls constituting the torsion beam. The gap is more preferably 1.5 mm or more, and still more preferably 2 mm or more. Note that, regarding the gap in the internal space, the closest distance between two inner surfaces facing each other is referred to as the “gap”. In FIG. 10, a gap in the internal space is exaggerated for easy understanding.

### Fourth Modification Example

As illustrated in FIG. 11, in a torsion beam 10D according to a fourth modification example, the axis of the center portion 11 of the torsion beam and the axis of the end portion 12 are shifted from each other. The two end portions 12 are arranged coaxially.

The axis of the center portion 11 of the torsion beam 10D and the axis of the end portion 12 of the torsion beam 10 are shifted from each other. That is, the center portion 11 and the end portion 12 of the torsion beam 10D are not limited to be coaxial. Therefore, for example, the degree of freedom of the shape of the torsion beam 10D can be increased. As a result, a layout can be diversified, for example, the torsion beam is designed so as to avoid other structures in a vehicle.

### Fifth Modification Example

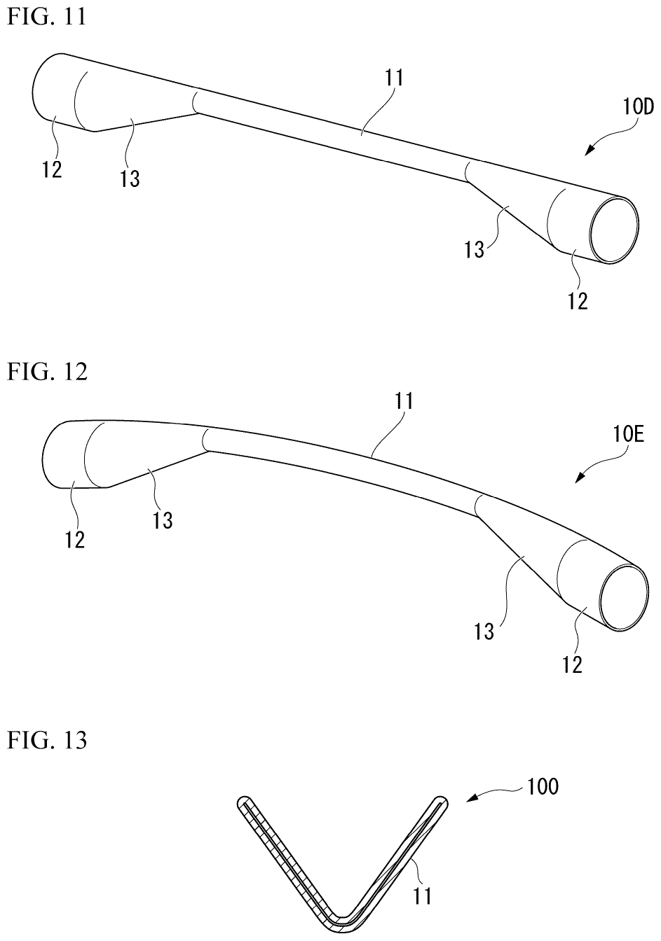

As illustrated in FIG. 12, in a torsion beam 10E according to a fifth modification example, the axis of the center portion 11 is a curve. That is, the center portion 11 is curved. The torsion beam 10E is formed by bending the torsion beam 10D according to the fourth modification example.

The axis of the center portion 11 of the torsion beam 10E is a curve. That is, the axis of the center portion 11 of the torsion beam 10E is not limited to a straight line. Therefore, for example, the degree of freedom of the shape of the torsion beam 10E can be increased. As a result, a layout can be diversified, for example, the torsion beam is designed so as to avoid other structures in a vehicle.

When the axis of the center portion 11 is a curve, it is conceivable to manufacture the torsion beam 10E by bending a steel pipe serving as a material of the torsion beam 10E.

Note that the technical scope of the present invention is not limited only to the above-described embodiment, and various modification can be made without departing from the gist of the present invention.

The average value t1 of the wall thickness at the center portion 11 and the average value t2 of the thickness at the end portion 12 may be different from each other. Therefore, an appropriate thickness average value can be adopted according to a position in the longitudinal direction. As a result, the quality of the torsion beam can be improved. Note that, for example, it is considered that t1<t2 is preferable in many cases from a viewpoint of attaching the end portion 12 of the torsion beam to a trailing arm.

As a method for making t1 and t2 different from each other, for example, a method for manufacturing a steel pipe serving as a material of the torsion beam by subjecting a tailored blank obtained by joining a plurality of steel sheets having different thicknesses to UO formation is conceivable.

A part of the torsion beam that is not the entire region in the longitudinal direction does not have to be an open cross section. For example, holes may be formed at one or more places of the torsion beam as long as performance of the torsion beam is not affected.

The material of the torsion beam does not have to be a steel pipe. Steel, a non-steel metal (an aluminum alloy, a titanium alloy, stainless steel, or the like), a non-metal (a carbon fiber-reinforced resin, a glass fiber-reinforced resin, or the like), and a composite thereof (a multilayer material or the like) may be used as the material. The shape of a pipe serving as the material does not have to be uniform in dimension or shape of a cross section, and may be a tapered pipe, a deformed cross-sectional pipe, or the like. Alternatively, a plate-shaped material may be formed into the shape of the torsion beam without passing through a tubular material, and then a joint of the plate may be joined to form a closed cross section. A method for forming the plate-shaped material into the shape of the torsion beam is not particularly limited, but for example, a method described in Japanese Patent No. 6477716 can be applied. The method for joining a joint of the plate after the plate-shaped material is formed into the shape of the torsion beam is not particularly limited, but for example, welding (arc welding, laser welding, seam welding, resistance welding, spot welding, or the like), pressure welding, brazing, bonding with an adhesive, or the like can be applied.

In addition, it is possible to appropriately replace a component in the embodiment with a well-known component without departing from the gist of the present invention, and the above-described modification examples may be appropriately combined with each other.

### EXAMPLES

Next, a verification test on the operation and effects will be described.

In this verification test, two types of torsion beams of Comparative Example 1 and Example 1 were prepared. In each of Comparative Example 1 and Example 1, a steel pipe was used for the torsion beam, and the steel pipe had a tensile strength of 800 MPa, a wall thickness of 2.9 mm, and a diameter of 94 mm. The wall thickness of the torsion beam was measured by using an ultrasonic measuring instrument and by measuring a cross section of a cut sample with a caliper after formation.

The shape of the torsion beam of Example 1 is the shape of the torsion beam 10C according to the third modification example illustrated in FIG. 10. The shape of the torsion beam of Comparative Example 1 is the shape of a torsion beam 100 according to Comparative Example illustrated in FIG. 13.

In this verification test, a weight reduction ratio was calculated from the weight (kg) of each torsion beam, and performance such as torsional rigidity or bending rigidity was verified. Results of the verification test are presented in Table 1.

TABLE 1

| | | | | | Proportion (%) | | |
|---|---|---|---|---|---|---|---|
| | | | | | between outer | | |
| | | | | | surface | | |
| | | | | | circumferential | | |
| | | | | | length of V- | | |
| | | | | | shaped cross- | | V- |
| | | | | | section of | Outer surface | shaped |
| | Average | | | | center portion | circumferential | ross- |
| | wall | Outer surface | | Length | and outer | length L1 | sectional |
| | thickness | circumferential | | (mm) of | surface | (mm) of V- | area S1 |
| | (mm) of | length L2 | Total | small | circumferential | shaped cross- | (mm²) of |
| | pipe end | (mm) of pipe | length | diameter | length of pipe | section of | center |
| | portion | end portion | (mm) | portion | end portion | center portion | portion |
| Comparative | 2.9 | 295.16 | 1054.5 | 485.6 | 99.43 | 295.2 | 1011.1 |
| Example 1 | | | | | | | |
| Example 1 | 2.9 | 295.16 | 1054.5 | 485.6 | 81.54 | 242.1 | 1003.6 |

| | Average | | | Minimum | | | |
|---|---|---|---|---|---|---|---|
| | wall | | | value | | | |
| | thicknesses | | Minimum | (mm) | | | |
| | t1 (mm) of | | R (mm) | between | | | |
| | center | | of inner | inner | | | |
| | portion in | S1/ | surface of | surfaces | | Bending | Torsional |
| | longitudinal | (L1 × | center | of center | Weight | rigidity | rigidity |
| | direction | t1) | portion | portion | (kg) | (kNmm/deg) | (kNmm/deg) |
| Comparative | 2.9 | 1.18 | 3.6 | 0 | 6.89 | 3900 | 95 |
| Example 1 | | | | | | | |
| Example 1 | 2.9 | 1.43 | 4.5 | 2 | 5.97 | 4000 | 102 |

The “outer surface circumferential length L2 (mm) of pipe end portion” in Table 1 is an outer surface circumferential length L2 (mm) in a transverse section of the end portion 12 of the torsion beam orthogonal to the longitudinal direction. The “length (mm) of small diameter portion” in Table 1 is the length (mm) of the center portion 11 of the torsion beam in the longitudinal direction. The “proportion (%) between outer surface circumferential length of V-shaped cross-section of center portion and outer surface circumferential length of pipe end portion” in Table 1 is a proportion between the outer surface circumferential length L1 of the V-shaped cross-section of the center portion 11 and the outer surface circumferential length L2 of the end portion 12. The “minimum R (mm) of inner surface of center portion” in Table 1 is R (mm) having the smallest bending radius of the center portion 11 in the circumferential direction. The “minimum value (mm) between inner surfaces of center portion” in Table 1 is a value (mm) at which a gap in the internal space of the center portion 11 is the smallest.

### FIELD OF INDUSTRIAL APPLICATION

According to the present invention, it is possible to provide a torsion beam in which bending rigidity is ensured while an excessive increase in weight is suppressed.

### BRIEF DESCRIPTION OF THE REFERENCE SYMBOLS

10, 10A, 10B, 10C, 10D, 10E Torsion beam
11 Center portion
12 End portion

1. A tubular torsion beam extending in a longitudinal direction, the torsion beam comprising a center portion and end portions connected to both sides of the center portion,
wherein a ratio S1/(L1×t1) determined by a cross-sectional area S1 including an internal space in a transverse section, which is a cross section orthogonal to the longitudinal direction in the center portion of the torsion beam in the longitudinal direction, an outer surface circumferential length L1 in the transverse section, and an average value t1 of a wall thicknesses in the center portion of the torsion beam in the longitudinal direction is 1.4 or more and less than 10.

2. The torsion beam according to claim 1, wherein a relationship between the average value t1 and the bending radius R satisfies 1.5t1<R in the transverse section having a portion with the smallest bending radius R of the center portion in a circumferential direction.

3. The torsion beam according to claim 1, wherein a material of the torsion beam has a tensile strength of 780 MPa or more.

4. The torsion beam according to claim 1, wherein in the transverse section in which a gap in the internal space is the smallest, the gap is 1.0 mm or more.

5. The torsion beam according to claim 1, wherein the outer surface circumferential length L1 is less than an outer surface circumferential length L2 in a transverse section, which is a cross section of the end portion orthogonal to the longitudinal direction.

6. The torsion beam according to claim 1, wherein the average value t1 is 2.5 mm or more.

7. The torsion beam according to claim 1, wherein in a cross section orthogonal to the longitudinal direction, a wall thickness of the torsion beam is −20% or more and 0% or less of a maximum value of the wall thickness.

8. The torsion beam according to claim 1, wherein the transverse section at the center portion does not include a portion protruding toward the internal space.

9. The torsion beam according to claim 1, wherein an axis of the center portion in the longitudinal direction and an axis of the end portion in the longitudinal direction are shifted from each other.

10. The torsion beam according to claim 9, wherein the axis of the center portion is a curve.

11. The torsion beam according to claim 1, wherein the average value t1 and an average value t2 of the wall thickness at the end portion are different from each other.

12. The torsion beam according to claim 3, wherein in the transverse section in which a gap in the internal space is the smallest, the gap is 1.0 mm or more.
